(19) United States
(12) Patent Application Publication
(10) Pub. No.: US 2003/0026960 A1
(43) Pub. Date: Feb. 6, 2003

(54) Sheet for ink jet recording

(75) Inventors: Hisao Yamada, Shizuoka-ken (JP); Kazuyuki Koike, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/167,500

(22) Filed: Jun. 13, 2002

(30) Foreign Application Priority Data
Jun. 19, 2001 (JP) 2001-184890

(51) Int. Cl. B32B 3/00

(52) U.S. Cl. 428/195

(57) ABSTRACT

A sheet for ink jet recording that stably holds an image printed thereon without image bleeding even if the sheet is stored in a hot and humid environment for a long period of time, that has excellent resistance to ozone and prevents the recorded image from becoming discolored through time, and that has excellent resistance to light in image portions. The sheet for ink jet recording includes at least one water-soluble compound whose basic skeleton has an ionization energy of 7.0 to 9.0 eV. The water-soluble compound preferably includes at least one of a hydroxyl group, a carboxyl group, and a sulfonic group in a molecule, and/or preferably has an I/O value of no less than 0.5.

### BACKGROUND OF THE INVENTION

1. Field of the Invention

The present invention relates to a recording material suitable for ink jet recording that uses a liquid ink including a dye or a pigment, such as water-based or oil-based ink, or an ink that is solid at room temperature and used for printing after being melted into a liquid. Particularly, the present invention relates to a sheet for ink jet recording which has excellent ink receptivity.

2. Description of the Related Art

Recently, various information processing systems have been developed along with the rapid development of the information industry. With this development, recording methods and apparatus suited to respective information processing systems have also been developed and put into practical use. One example of such a recording method is ink jet recording, which has been widely used not only in offices but also in homes because it enables recording on various types of recording materials and can be conducted with relatively inexpensive, compact, and quiet equipment.

Due to increases in the resolution with which ink jet printers can print images, it has also become possible to obtain recorded images of a quality as high as that of photographs. With the development of ink jet printers, various types of sheets for ink jet recording (hereinafter, may be simply referred to as “sheets”) have been developed.

The following characteristics are generally demanded of sheets for ink jet recording: (1) they must be able to quickly absorb ink, so that the ink quickly dries; (2) diameters of ink dots formed on the sheets must be uniform (i.e., no bleeding); (3) they must have good graininess; (4) the circularity with which dots are formed on the sheets must be high; (5) they must have high color density; (6) they must have high saturation (i.e., no dullness); (7) printed image areas of the sheets must have good resistance to light and water; (8) images recorded on the sheets should not bleed when the sheets are stored over a long period of time; (9) they must have high whiteness; (10) they must not yellow or become discolored when stored over a long period of time; (11) they must be able to retain stable dimensions and have good resistance to deformation (i.e., curls must be sufficiently small); and (12) they must have good running properties.

In addition to the above, glossiness, surface smoothness, texture similar to that of silver halide photographs, and the like are also required for photographic glossy paper used to obtain recorded images of a quality as high as that of photographs.

Sheets in which a water-soluble binder and a pigment such as silica are applied onto a base such as paper or a plastic film are described in Japanese Patent Application Laid-Open (JP-A) Nos. 55-51583, 55-144172, 55-150395, 56-148582, 56-148583, 56-148584, 56-148585, 57-14091, 57-38185, 57-129778, 57-129979, 60-219084, and 60-245588. However, all of the sheets proposed in these application have very low glossiness, which is insufficient for use of the sheets as photographic glossy paper.

Sheets for recording that use pseudo-boehmite sol and a water-soluble binder are also proposed in JP-A Nos. 2-276670, 3-215082, 3-281383, and 6-199035. Although these sheets have adequate glossiness, there are problems in that it costs a lot to manufacture the pseudo-boehmite particles used in the sheets and it is difficult to prepare coating solutions.

JP-A No. 4-223190 proposes a sheet that includes a base paper comprising 0.1 g/m² of borax or boric acid having disposed thereon a recording layer comprising 5 to 20 g/m² of synthetic silica and polyvinyl alcohol (PVA). However, the disclosed sheet is devised simply to improve the strength of the recording layer with a small amount of a binder, and has poor glossiness. Therefore, this sheet is inadequate for use as photographic glossy paper.

Recording materials in which various types of water-soluble polymers are used to obtain glossiness have also been proposed. For example, recording materials comprising a base such as paper or a plastic film applied with polyvinyl alcohol, polyvinyl pyrrolidone, or gelatin are described in JP-A Nos. 58-89391, 58-134784, 58-134786, 60-44386, 60-132785, 60-145879, 60-168651, and 60-171143. Although these sheets also have excellent glossiness, ink jetted thereon does not dry quickly. The sheets are thus inadequate for use as photographic glossy paper.

JP-A Nos. 10-119423 and 10-217601 propose sheets for ink jet recording that comprise a base disposed with a highly porous colorant receiving layer that contains fine inorganic pigment particles and a water-soluble resin. Each of these sheets exhibits excellent ink absorption, high ink receptivity, which enables formation of a high-resolution image, and has high glossiness. However, since both sides of the base are coated with a resin such as polyethylene from the viewpoints of glossiness and texture, a high boiling solvent included in the colorant receiving layer does not evaporate, and the solvent is not absorbed by the base. Therefore, the high boiling solvent remains in the colorant receiving layer. When the sheet is stored under hot and humid conditions for a long time after printing, a problem arises in that the solvent is dispersed in the colorant receiving layer together with a dye, thereby causing image bleeding (may be referred to later in this specification as “bleeding with time”).

Thus, there still has not been provided a sheet for ink jet recording that has good ink absorption, a sufficiently smooth recording surface, good glossiness, on which a high-resolution and high-density image can be formed, that can ensure ink receptivity so that an image formed on the sheet is highly resistant to light and water, that can stably hold an image printed thereon without the image bleeding when the sheet is stored under hot and humid conditions for a long period of time, that has excellent resistance to ozone, and that can prevent the recorded image from becoming discolored through time.

### SUMMARY OF THE INVENTION

The present invention is intended to solve the conventional problems described above and achieve the following object.

Namely, an object of the present invention is to provide a sheet for ink jet recording that stably holds an image printed thereon without the image bleeding even if the sheet is stored in a hot and humid environment for a long period of time, that has excellent resistance to ozone and prevents the recorded image from becoming discolored through time, and that has excellent resistance to light in image portions.

A first aspect of the present invention is a sheet for ink jet recording, comprising at least one water-soluble compound whose basic skeleton has an ionization energy of 7.0 to 9.0 eV.

A second aspect of the present invention is a sheet for ink jet recording comprising a base having formed thereon a colorant receiving layer, the colorant receiving layer having a three-dimensional mesh structure with a porosity of 50 to 80% and including inorganic particles (x) having an average primary particle diameter of no more than 20 nm, a water-soluble resin (y) at a mass ratio (x:y) of 1.5:1 to 10:1, a crosslinking agent for the water-soluble resin, an organic cationic mordant, and at least one water-soluble compound whose basic skeleton has an ionization energy of 7.0 to 9.0 eV.

### DESCRIPTION OF THE PREFERRED EMBODIMENT

A preferable embodiment of a sheet for ink jet recording of the present invention (hereinafter, may be referred to simply as “the sheet”) comprises a base having disposed thereon a colorant receiving layer that includes at least one water-soluble compound whose basic skeleton has an ionization energy of 7.0 to 9.0 eV. With this structure, resistance of recorded images to ozone is particularly improved, image portions are prevented from becoming discolored through time due to exposure to ozone, and bleeding with time is prevented.

The basic skeleton is not particularly limited as long as its ionization energy is 7.0 to 9.0 eV. Examples include dialkyl thioether, dialkyl disulfide, trialkylphosphine, triphenylphosphine, trialkylamine, dialkylamine, monoalkylamine, aniline, phenol, hydroquinone, anisole, styrene, stilbene, cyclopentadiene, indan, indene, hydrazine, indole, quinoline, imidazole, thiophene, pyrrole, furan, and the like. Hydrazine, quinoline, imidazole, and dialkyl thioether are preferable, and dialkyl thioether is most preferable.

When the ionization energy of the basic skeleton is less than 7.0 eV, color development in background portions becomes significant. When the ionization energy exceeds 9.0 eV, resistance to ozone and light deteriorates. The ionization energy of the basic skeleton is more preferably 7.2 to 8.8 eV, and most preferably 7.5 to 8.5 eV.

Examples of the water-soluble compound include compounds containing in a molecule at least one of a hydroxyl group, a carboxyl group, and a sulfonic group as a water-soluble substituent.

In view of water solubility, an I/O value of the compound is preferably 0.5 or more, more preferably 0.8 or more, and most preferably 1.2 or more. I/O value refers to a parameter representing the lipophilic/hydrophilic ratio in a compound or a substituent, and is minutely described in Yoshio Koda's Yûki gainenzu: kiso to ôyô (“Conceptual Diagrams of Organic Compounds: Fundamentals and Application”) (Tokyo: Sankyô Shuppan, 1984). “I” represents inorganic nature, while “O” represents organic nature. The larger the I/O value, the larger the inorganic nature. Specific examples relating to the I/O value are described below.

Typical examples of the I value include 200 in —NHCO— group, 240 in —NHSO₂— group, and 60 in —COO— group. For example, in the case of —NHCOC₅H₁₁, the number of carbon atoms is 6, and the O value is 20×6=120. Since I=200, I/O≈1.67.

Although specific examples of the compound (exemplified compounds 1-1 through 1-46) are given below, the compound of the present invention is not limited to these examples.

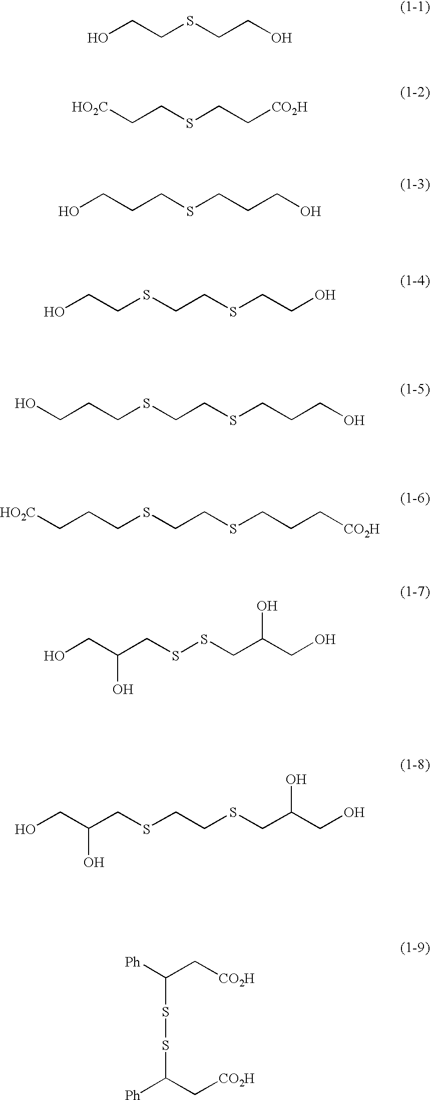

P(CH₂CH₂OH)₃ P(CH₂CH₂CH₂OH)₃ Ph₂N(CH₂CH₂OH) Ph₂N(CH₂CH₂OH) (1-10) (1-11) (1-12) (1-13)

Me₂N(CH₂CH₂CH₂OH) MeN(CH₂CH₂CH₂OH)₂ N(CH₂CHOH)₃ N(CH₂CH₂CH₂OH)₃ (1-14) (1-15) (1-16) (1-17)

(HOCH₂CH₂)₂NCH₂CH₂N(CH₂CH₂OH)₂ (HOCH₂CH₂)₂NCH₂CH₂CH₂N(CH₂CH₂OH)₂ (1-18) (1-19)

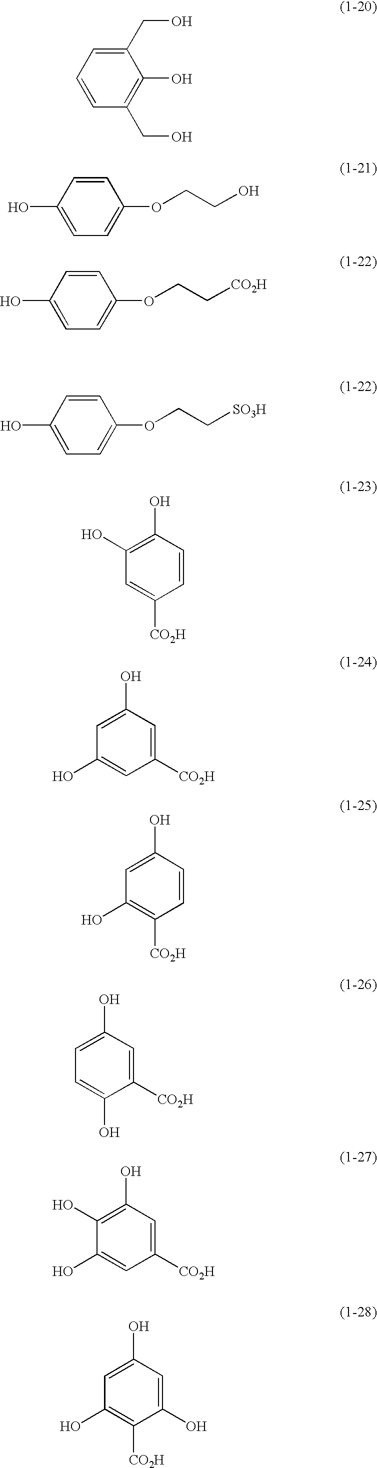

The content of the compound is preferably 0.1 to 10% by mass, and more preferably 1 to 5% by mass, based on the total solids of the colorant receiving layer. The content of 0.1 to 10% by mass is preferable in terms of resistance to ozone and water, and bleeding with time.

The sheet also preferably includes at least one metal compound. Examples of the metal compound include alkali metal compounds, alkali earth metal compounds, and transition metal compounds, such as compounds of magnesium, calcium, aluminum, iron, cobalt, nickel, zinc, and the like. Particularly, the compounds of magnesium, calcium, aluminum, and zinc can be appropriately used. More specific examples include magnesium chloride, zinc chloride, calcium chloride, magnesium acetate, calcium acetate, zinc acetate, magnesium sulfate, calcium sulfate, zinc sulfate, and aluminum sulfate. Magnesium chloride, zinc chloride, and calcium chloride are preferable.

The content of the metal compound is preferably 0.1 to 10% by mass, and more preferably 1 to 5% by mass, based on the total solids of the colorant receiving layer. The content of 0.1 to 10% by mass is preferable in terms of resistance to light and water, and bleeding with time.

The colorant receiving layer has a three-dimensional mesh structure with a porosity of 50 to 80% and includes, as constituents, inorganic particles (x) having an average primary particle diameter of 20 nm or less and a water-soluble resin (y) at a mass ratio (x:y) of 1.5:1 to 10:1. The colorant receiving layer preferably includes a crosslinking agent for the water-soluble resin, an organic cationic mordant, and the water-soluble compound whose basic skeleton has an ionization energy of 7.0 to 9.0 eV. Further, the colorant receiving layer may include other additives such as a light resistance improving agent, if necessary.

In view of water solubility, the compound included in the colorant receiving layer preferably includes at least one of a hydroxyl group, a carboxyl group, and a sulfonic group in a molecule and/or preferably has an I/O value of 0.5 or more.

The colorant receiving layer also preferably includes at least one of the metal compounds listed above in connection with the sheet.

Three-Dimensional Mesh Structure

Next, the three-dimensional mesh structure will be described.

Inorganic Pigment Particles

Examples of the inorganic pigment particles include silica particles, colloidal silica, titanium dioxide, barium sulfate, calcium silicate, zeolite, kaolinite, halloysite, mica, talc, calcium carbonate, magnesium carbonate, calcium sulfate, boehmite, and the like. Silica particles are particularly preferable.

Because of their particularly large specific surface area, the silica particles have high ink absorption and high ink-holding efficiency. Further, since the silica particles have a low refractive index, if the particles are broken up until they have an appropriate particle diameter, the colorant receiving layer can be made transparent, and high color density and good color development can be obtained. Transparency of the colorant receiving layer is important not only in applications requiring transparency such as overhead projectors but also in application of the colorant receiving layer to sheets for recording such as photographic glossy paper, in terms of obtaining high color density and good color development.

The inorganic pigment particles relating to the present invention have an average primary particle diameter of 20 nm or less. The particle diameter is more preferably 10 nm or less, and most preferably 3 to 10 nm.

Each of the silica particles has silanol groups on the surface thereof. Since the silica particles easily adhere to each other by hydrogen bonds of the silanol groups, when the average primary particle diameter is 20 nm or less, a highly porous structure can be formed with which ink absorption can be effectively improved.

Silica particles can be broadly classified into wet particles and dry particles based on the method by which they are produced.

Wet silica may be formed by, for example, subjecting silicate to acid decomposition to form active silica, which is in turn moderately polymerized, coagulated and precipitated. Dry silica may be obtained by, for example, subjecting silicon halide to vapor-phase hydrolysis at a high temperature (flame hydrolysis), or by heating, reducing and vaporizing silica sand and coke in an electric furnace by arc and then oxidizing the same with air (arc process).

Wet silica and dry silica obtained by these methods have different characteristics because of differences in the density of the silanol groups on the surface, the presence of pores, and the like. Dry silica (silicic anhydride) is particularly preferable since it easily forms a highly porous three-dimensional structure. Although the reason for this is not entirely clear, it is assumed as follows. In the case of wet silica, the density of the silanol groups on the surfaces of the particles is as high as 5 to 8/nm², and the silica particles easily aggregate at high density. In the case of dry silica, the density of the silanol groups on the surfaces of the particles is as low as 2 to 3/nm², and the particles sparsely flocculate. It is therefore assumed that this is the reason why dry silica forms a highly porous structure.

In the present invention, silica (silica particles) in which the density of the silanol groups on the surface of the particle is 2 to 3/nm² is preferably used. Further, pseudo-boehmite is preferably used as the inorganic pigment particles in terms of forming the porous structure.

Water-Soluble Resin

Examples of the water-soluble resin include resins having hydroxyl groups as hydrophilic structural units, such as polyvinyl alcohol (PVA), cation modified polyvinyl alcohol, anion modified polyvinyl alcohol, silanol modified polyvinyl alcohol, polyvinyl acetal, cellulose-based resins (methyl cellulose (MC), ethyl cellulose (EC), hydroxyethyl cellulose (HEC), carboxymethyl cellulose (CMC), and the like), quitins, chitosans, and starch; resins having ether bonds, such as polyethylene oxide (PEO), polypropylene oxide (PPO), polyethylene glycol (PEG), and polyvinyl ether (PVE); and resins having amide groups or amide bonds, such as polyacrylamide (PAAM), polyvinyl pyrrolidone (PVP), and the like. Other examples of the water-soluble resin include resins having a carboxyl group as a dissociative group, such as polyacrylate, maleic resins, alginate, and gelatins. Among these resins, polyvinyl alcohol is particularly preferable.

The content of the water-soluble resin is preferably 9 to 40% by mass, and more preferably 16 to 33% by mass, based on the mass of the total solids of the colorant receiving layer. When the content of the water-soluble resin is 9 to 40% by mass, the layer is prevented from becoming weak and easily cracking when the layer is dried. Further, since the pores are not easily blocked by the resin, it is possible to prevent a decrease in ink absorption resulting from a decrease in the porosity.

The inorganic pigment particles and the water-soluble resin, which are the main components of the colorant receiving layer, may respectively comprise a single material or a mixture of materials.

Further, the type of resin that is combined with the silica particles is important in view of transparency. When dry silica is used, polyvinyl alcohol (PVA) is preferable as the water-soluble resin. PVA having a saponification ratio of 70 to 99% is more preferable, and PVA having a saponification ratio of 70 to 90% is particularly preferable.

PVA has a hydroxyl group as its structural unit. Since the hydroxyl group and the silanol groups on the surfaces of the silica particles form a hydrogen bond, it becomes easy to form a three-dimensional mesh structure with secondary particles of the silica particles serving as chain units. It can be considered that a colorant receiving layer having a porous structure of high porosity can be formed by forming the three-dimensional mesh structure.

In ink jet recording, the porous colorant receiving layer rapidly absorbs ink due to a capillary phenomenon, whereby uniformly circular dots can be formed with no bleeding of the ink.

Ratio of Inorganic Pigment Particles to Water-Soluble Resin

The mass ratio of the inorganic pigment particles (preferably silica particles, x) to the water-soluble resin (y) (PB ratio (x:y), namely, the mass of the inorganic pigment particles with respect to 1 part by mass of the water-soluble resin) greatly affects the structure of the colorant receiving layer. Namely, the larger the mass ratio, the larger the porosity, the pore volume, and the surface area (per unit mass).

The colorant receiving layer relating to the present invention has a three-dimensional mesh structure which includes, as the constituents, the inorganic pigment particles and the water-soluble resin at a mass ratio (x:y) of 1.5:1 to 10:1. When the mass ratio exceeds 10:1, the layer becomes weak and easily cracks when it is dried. When the mass ratio is less than 1.5:1, the pores are easily blocked by the resin, whereby the porosity decreases and ink absorption becomes poor.

The colorant receiving layer needs to be sufficiently strong enough to withstand stress that might be applied to the sheet when the sheet is conveyed in an ink jet printer. Further, the colorant receiving layer needs to have sufficient strength so as to prevent cracks, peeling, and the like thereof when recording paper is cut into sheets.

In this case, the mass ratio is preferably 5:1. In view of ensuring fast ink absorption in the ink jet printer, the mass ratio is preferably 2:1 or more.

When a coating solution obtained by, for example, completely dispersing dry silica particles having an average primary particle diameter of 20 nm or less and a water-soluble resin in an aqueous solution at a mass ratio of 2:1 to 5:1 is applied onto the base and dried, the three-dimensional mesh structure is formed with secondary particles of the silica particles being chain units. As a result, a translucent porous film having an average pore diameter of 30 nm or less, a porosity of 50 to 80%, a pore volume of 0.5 ml/g or more, and a specific surface area of 100 m²/g or more can be easily formed. Since the colorant receiving layer of the present invention has a three-dimensional mesh structure having a porosity of 50 to 80%, the layer can improve ink absorption.

Crosslinking Agent

The colorant receiving layer (porous layer) further includes a crosslinking agent and is solidified by crosslinking of the water-soluble resin by the crosslinking agent.

The crosslinking agent which can crosslink the water-soluble resin may be appropriately selected in consideration of compatibility with the water-soluble resin used for the colorant receiving layer. Boron compounds are preferable in terms of rapid crosslinking. Examples include borax, boric acid, borate (e.g., orthoborate, InBO₃, ScBO₃, YBO₃, LaBO₃, and Mg₃(BO₃)₂, Co₃(BO₃)₂, diborate (e.g., Mg₂B₂B₅ and Co₂B₂O₅), metaborate (e.g., LiBO₂, Ca(BO₂)₂, NaBO₂, and KBO₂), tetraborate (e.g., Na₂B₄O₇.10H₂O), pentaborate (e.g., KB₅O₈.4H₂O, Ca₂B₆O₁₁.7H₂O, and CsB₅O₅), glyoxal, melamine.formaldehyde (e.g., methylol melamine and alkylated methylol melamine), methylolurea, resol resin, polyisocyanate, epoxy resin, and the like. Borax, boric acid, and borate are preferable since they rapidly cause crosslinking. The use of borax, boric acid, or borate in combination with polyvinyl alcohol as the water-soluble resin is particularly preferable.

When gelatin is used as the water-soluble resin, compounds known as hardeners for gelatin can be used as the crosslinking agent. Examples thereof include aldehyde-based compounds such as formaldehyde, glyoxal, and glutaraldehyde; ketone-based compounds such as diacetyl and cyclopentanedione; activated halogen compounds such as bis(2-chloroethylurea)-2-hydroxy-4,6-dichloro-1,3,5-triazine, and 2,4-dichloro-6-S-triazine sodium salt; activated vinyl compounds such as divinylsulfonic acid, 1,3-vinylsulfonyl-2-propanol, N,N′-ethylenebis(vinylsulfonylacetamide), and 1,3,5-triacryloil-hexahydro-S-triazine; N-methylol compounds such as dimethylolurea and methyloldimethylhydantoin; isocyanate-based compounds such as 1,6-hexamethylene diisocyanate; the aziridine-based compounds described in U.S. patent application Ser. Nos. 3,017,280 and 2,983,611; the carboxyimide-based compounds described in U.S. patent application Ser. No. 3,100,704; epoxy-based compounds such as glycerol triglycidyl ether; ethylene imino-based compounds such as 1,6-hexamethylene-N,N′-bisethyleneurea; halogenated carboxyaldehyde-based compounds such as mucochloric acid and mucophenoxychloric acid; dioxane-based compounds such as 2,3-dihydroxydioxane; chrome alum, potassium alum, zirconium sulfate, chrome acetate, and the like.

The above crosslinking agents may be used alone, or a combination of two or more may be used.

A solution containing the above crosslinking agent is preferably applied simultaneously with the coating solution for forming the porous colorant receiving layer (i.e., the coating solution for the colorant receiving layer) or before a coating layer, which has been formed by applying the coating solution for the colorant receiving layer, presents a lapsed drying rate. The application of the crosslinking agent can effectively prevent cracks that can otherwise form while the coating layer is drying.

Namely, the crosslinking agent-containing solution permeates the coating layer at the same time the coating solution is applied or before the coating layer presents a lapsed drying rate, and rapidly reacts with the water-soluble resin in the coating layer to gelate (solidify) the water-soluble resin. As a result, the strength of the coating layer significantly improves instantly.

The crosslinking agent-containing solution is prepared by dissolving the crosslinking agent in water and/or an organic solvent. The concentration of the crosslinking agent in the solution is preferably 0.05 to 10% by mass, and more preferably 0.1 to 7% by mass, based on the mass of the solution.

Water is generally used as a solvent for the crosslinking agent-containing solution. The solvent may also be a mixed solvent of water and a compatible organic solvent.

Any organic solvent can be used as long as the crosslinking agent can be dissolved in the organic solvent. Examples include alcohols such as methanol, ethanol, isopropyl alcohol, and glycerin; ketones such as acetone and methylethylketone; esters such as methyl acetate and ethyl acetate; aromatic solvents such as toluene; ethers such as tetrahydrofuran; and halogenated carbon-based solvents such as dichloromethane.

Organic Cationic Mordant

When an organic cationic mordant is incorporated into the colorant receiving layer, the organic cationic mordant interacts with a liquid ink having an anionic dye as a colorant, and can stabilize the colorant and improve resistance to water.

When the mordant is directly added to the coating solution for the colorant receiving layer, the inorganic pigment particles having anionic charges, such as silica, may coagulate. However, it is not necessary to worry about the coagulation of the inorganic pigment particles if the coating solution and the mordant are prepared and coated separately. Therefore, in the present invention, the mordant is preferably incorporated into the crosslinking agent-containing solution.

Preferable examples of the organic cationic mordant include polymer mordants having primary to tertiary amino groups and salts thereof or a quaternary ammonium salt group. Cationic non-polymer mordants can also be used.

Preferable polymer mordants are homopolymers of the following monomers having bases, or copolymers or condensation polymers of the aforementioned monomers and other monomers. Polyallylamine-based homopolymers, copolymers, or condensation polymers are particularly preferable.

Examples of the monomers include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylamonium chloride, N,N-dimethyl-N-(4-methyl)benzyl-N-p-vinylbenzylammonium chloride, N,N-dimethyl-N-phenyl-N-p-vinylbenzylammonium chloride, allylamine, methylallylamine, ethylallylamine, n-propylallylamine, i-propylallylamine, n-butylallylamine, i-butylallylamine, sec-butylallylamine, t-butylallylamine, n-pentylallylamine, n-hexylallylamine, benzylallylamine, dimethylallylamine, diethylallylamine, di-n-propylallylamine, di-i-propylallylamine, di-n-butylallylamine, allyl-trimethylammonium chloride, allyl-trimethylammonium bromide, allyl-trimethylammonium iodide, allyl-trimethylammonium sulfonate, allyl-trimethylammonium acetate, allyl-triethylammonium fluoride, and allyl-triethylammonium bromide; trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N,-triethyl-N-2-(3-vinylphenyl)ethylammonium chloride, N,N-diethyl-N-methyl-N-2-(4-vinylphenyl)ethylammonium chloride, and N,N-diethyl-N-methyl-N-2-(4-vinylphenyl)ethylammonium acetate; quaternary compounds of N,N-dimethylaminoethyl(meta)acrylate, N,N-diethylaminoethyl(meta)acrylate, N,N-dimethylaminopropyl(meta)acrylate, N,N-diethylaminopropyl(meta)acrylate, N,N-dimethylaminoethyl(meta)acrylamide, N,N-diethylaminoethyl(meta)acrylamide, N,N-dimethylaminopropyl(meta)acrylamide, or N,N-diethylaminopropyl(meta)acrylamide, and methyl chloride, methyl bromide, ethyl bromide, methyl iodide, or ethyl iodide, and sulfonate, alkyl sulfonate, acetate, or alkyl carbonate of the quaternary compounds, whose anion has been substituted.

Specific examples include trimethyl-2-(metacryloyloxy)ethylammonium chloride, triethyl-2-(metacryloyloxy)ethylammonium chloride, trimethyl-2-(acryloyloxy)ethylammonium chloride, triethyl-2-(acryloyloxy)ethylammonium chloride, trimethyl-3-(metacryloyloxy)propylammonium chloride, triethyl-3-(me tacryloyloxy)propylammonium chloride, trimethyl-2-(metacryloylamino)ethylammonium chloride, triethyl-2-(metacryloylamino)ethylammonium chloride, trimethyl-2-(acryloylamino)ethylammonium chloride, triethyl-2-(acryloylamino)ethylammonium chloride, trimethyl-3-(metacryloylamino)propylammonium chloride, triethyl-3-(metacryloylamino)propylammonium chloride, trimethyl-3-(acryloylamino)propylammonium chloride, and triethyl-3-(acryloylamino)propylammonium chloride; N,N-dimethyl-N-ethyl-2-(metacryloyloxy)ethylammonium chloride, N,N-diethyl-N-methyl-2-(me tacryloyloxy)ethylammonium chloride, N,N-dimethyl-N-ethyl-3-(acryloylamino)propylammonium chloride, trimethyl-2-(metacryloyloxy)ethylammonium bromide, trimethyl-3-(acryloylamino)propylammonium bromide, trimethyl-2-(metacryloyloxy)ethylammonium sulfonate, and trimethyl-3-(acryloylamino)propylammonium acetate.

Examples of monomers that can be copolymerized include N-vinylimidazole and N-vinyl-2-methylimidazole.

The aforementioned polymer mordants may be water-soluble polymers, or may be latex particles which are dispersed in water.

Preferable examples of the polymer mordant further include polydiallyldimethylammonium chloride, polymetacryloyloxyethyl-β-hydroxyethyldimethylammonium chloride, polyethylenimine, polyamide-polyamine resins, cationic starch, dicyandiamideformalin condensates, polymers of dimethyl-2-hydroxypropylammonium salt, polyamidine, and polyvinylamine.

The molecular weight of the mordant is preferably about 1000 to 200000. When the molecular weight is within the range of 1000 to 200000, it is possible for the formed colorant receiving layer to exhibit sufficient water resistance, and handling characteristics do not deteriorate due to the viscosity of the layer becoming too high.

A compound having a quaternary ammonium salt group and having a total number of carbon atoms of 12 or more, and preferably 18 or more, is suitably used as the non-polymer mordant.

The content of the organic cationic mordant is preferably 0.5 to 25.0% by mass, and more preferably 1.0 to 15.0% by mass, based on the mass of the total solids of the colorant receiving layer.

When the content of the organic cationic mordant is 0.5 to 25.0% by mass, it is possible for the formed colorant receiving layer to exhibit sufficient water resistance and sufficient ink absorption.

Other Additives

The sheet may include various types of ultraviolet absorbents, antioxidants, and light resistance improvers such as singlet oxygen quenchers to suppress deterioration of the colorant.

Examples of the ultraviolet absorbents include cinnamic acid derivatives, benzophenone derivatives, and benzotriazolylphenol derivatives. Specific examples include α-cyano-phenylbutyl cinnamate, o-benzotriazolphenol, o-benzotriazol-p-chlorophenol, o-benzotriazol-2,4-di-t-butylphenol, and o-benzotriazol-2,4-di-t-octylphenol. Hindered phenol compounds can also be used as the ultraviolet absorbents. Specifically, a phenol derivative, in which at least one of the second position and the sixth position is substituted for a branched alkyl group, is preferable.

Further, benzotriazol-based ultraviolet absorbents, salicyclic acid-based ultraviolet absorbents, cyanoacrylate-based ultraviolet absorbents, and oxalic acid anilide-based ultraviolet absorbents can also be used. These ultraviolet absorbents are described in JP-A Nos. 47-10537, 58-111942, 58-212844, 59-19945, 59-46646, 59-109055, and 63-53544, Japanese Patent Application Publication (JP-B) Nos. 36-10466, 42-26187, 48-30492, 48-31255, 48-41572, 48-54965, and 50-10726, and U.S. Pat. Nos. 2,719,086, 3,707,375, 3,754,919, and 4,220,711.

Optical whitening agents, such as a coumarin-based optical whitening agent, can also be used as the ultraviolet absorbents. Specific examples of the coumarin-based optical whitening agent are described in JP-B Nos. 45-4699 and 54-5324.

Examples of the antioxidants include those disclosed in European Patent Application Laid-Open Nos. 223739, 309401, 309402, 310551, 310552, and 459416, German Patent Application Laid-Open No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679. 62-282885, 62-262047, 63-051174, 63-89877, 63-88380, 66-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437, and 5-170361, JP-B Nos. 48-43295 and 48-33212, and U.S. Pat. Nos. 4,814,262 and 4,980,275.

Specific examples include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4-tetrahydroquinoline, cyclohexanoic acid nickel, 2,2-bis(4-hydroxyphenyl)propane, 1,1-bis(4-hydroxyphenyl)-2-ethylhexane, 2-methyl-4-methoxy-diphenylamine, and 1-methyl-2-phenylindole.

The light resistance improver may be used alone, or two or more may be used in combination. The light resistance improver may be water-soluble, dispersed, or emulsified, or included in a microcapsule. The amount of the light resistance improver added is preferably 0.01 to 10% by mass of the coating solution for the colorant receiving layer.

The sheet may also include: acids or alkalis as inorganic salts or pH regulators to improve dispersion of the inorganic pigment particles; various types of surfactants to improve coatability and surface quality; ion-conductive surfactants or electron-conductive metal oxide particles to suppress charging caused by friction or stripping of the surface; and various types of matting agents to reduce frictional properties of the surface.

Base

The base of the sheet may be a transparent material, such as plastic, or an opaque material, such as paper. In the present invention, the base is preferably a transparent base or a highly glossy opaque base, in terms of utilizing the transparency of the colorant receiving layer.

Materials that can be used as the transparent base preferably can withstand the radiation heat of an overhead projector or a backlight display. Examples of such materials include polyesters such as polyethylene terephthalate, cellulose esters such as nitrocellulose, cellulose acetate, and cellulose acetate butylate, polysulfone, polyphenylene oxide, polyimide, polycarbonate, and polyamide. Polyesters are preferable, and polyethylene phthalate is more preferable.

Although the thickness of the transparent base is not particularly limited, it is preferably 50 to 200 μm in view of handling.

Materials that can be used as the highly glossy opaque base are preferably materials whose surface, on which the colorant receiving layer is to be formed, has a glossiness of 40% or more. The glossiness is a value determined in accordance with the method described in JIS P-8142 (i.e., a method for testing relative-specular glossiness of paper and board using a mirror inclined at 75°).

Examples of the highly glossy opaque base include highly glossy paper such as art paper, coated paper, cast-coated paper, and baryta paper used as a base for silver halide photography; polyesters such as polyethylene terephthalate (PET); cellulose esters such as nitrocellulose, cellulose acetate, and cellulose acetate butylate; glossy films (which may be subjected to surface calendering) made opaque by incorporating a white pigment or the like into plastic films such as polysulfone, polyphenylene oxide, polyimide, polycarbonate, or polyamide; and bases formed by providing a coating layer of polyolefine including or not including a white pigment on the aforementioned paper, transparent plastic films, and white pigment-containing plastic films.

Another example of the base is a foamed polyester film containing a white pigment (e.g., foamed PET whose pores are formed by incorporating polyolefine particles and drawing).

Further, polyolefine-coated paper (a paper base having a white pigment-containing polyolefine layer formed thereon), which is generally used as a base for silver halide photography, or special paper having a metal deposition layer formed thereon can also be appropriately used.

A base for silver halide photography on which a white pigment-containing polyolefine layer is formed, a polyester (preferably PET) film on which a white pigment-containing polyolefine layer is formed, a polyester film containing a white pigment, or a foamed polyester film containing a white pigment is particularly preferable.

Although the thickness of the opaque base is not particularly limited, it is preferably 50 to 300 μm in view of handling.

Moreover, a base which has been subjected to a corona discharge treatment, a glow discharge treatment, a flame treatment, or an ultraviolet irradiation treatment so that the base can adhere to the colorant receiving layer, may be used.

Manufacturing of Sheet for Ink Jet Recording

The colorant receiving layer is preferably obtained by applying, when the coating solution containing the inorganic pigment particles and the water-soluble resin is coated onto the base, the solution at least containing the crosslinking agent and the cationic mordant (i.e., the crosslinking agent-containing solution) onto the coated layer simultaneously with the coating of the coating solution or before the coated layer presents a lapsed drying rate, so that the crosslinking agent solidifies the water-soluble resin.

Further, the colorant receiving layer can also be obtained by simultaneously applying the coating solution containing the inorganic pigment particles and the water-soluble resin, and the solution containing the crosslinking agent, onto the base with a barrier solution formed by a material not reacting with the crosslinking agent being interposed therebetween, and by solidifying the solutions. In this case, the mordant is included in at least one of the crosslinking agent-containing solution and the barrier solution.

As described above, in the present invention, water resistance of the colorant receiving layer is improved by simultaneously applying the crosslinking agent and the mordant. Namely, when the organic cationic mordant is added to the coating solution for the colorant receiving layer, the inorganic pigment particles might aggregate in the presence of the mordant because they have anion charges on the surface of silica or the like. Therefore, if the solution containing the mordant and the coating solution for the colorant receiving layer are separately prepared and applied, it is unnecessary to worry about the aggregation of the inorganic pigment particles, and the cationic mordant can be selected from a wider range of mordants.

In the present invention, the coating solution for the colorant receiving layer that includes at least the inorganic pigment particles and the water-soluble resin (hereinafter may be referred to simply as the “coating solution for the colorant receiving layer”) can be prepared, for example, as follows.

Silica particles having an average primary particle diameter of 20 nm or less arc added to water (e.g., 10 to 20% by mass), and the resulting mixture is dispersed in a high-speed rotation wet colloid mill (e.g., CLEARMIX manufactured by M TECHNIQUE Co., LTD.) at a rotational speed of 10000 rpm (preferably 5000 to 20000 rpm) for 20 minutes (preferably 10 to 30 minutes). Thereafter, an aqueous solution of polyvinyl alcohol is added to the dispersion (so that the weight of the PVA is, for example, about ⅓ of the weight of the silica), and the resultant mixture is further dispersed under the same conditions as described above to obtain the coating solution for the colorant receiving layer. The coating solution thus obtained is uniform sol. A surfactant, a pH regulator, an antistatic agent, and the like can also be added to the coating solution for the colorant receiving layer, if necessary.

The colorant receiving layer can be formed by applying the coating solution onto the base using, for example, extrusion die coaters, air doctor coaters, bread coaters, rod coaters, knife coaters, squeeze coaters, reverse roll coaters, bar coaters, and the like.

In the present invention, the colorant receiving layer solidified by crosslinking can be obtained by introducing the solution containing at least the crosslinking agent and the mordant (i.e., the crosslinking agent-containing solution) into the coating layer, which has been formed by applying the coating solution for the colorant receiving layer, and by drying the solution.

The aforementioned compounds and metal compounds may be included in the colorant receiving layer by being incorporated into the coating solution for the colorant receiving layer or being incorporated into the crosslinking agent-containing solution. The compounds may be included in the colorant receiving layer at any time.

The crosslinking agent-containing solution may be applied after the coating solution for the colorant receiving layer has been applied and before the coating layer thus formed presents a lapsed drying rate. Namely, the colorant receiving layer is preferably manufactured by incorporating the crosslinking agent-containing solution, which includes at least the crosslinking agent and the mordant, into the coating solution for the colorant receiving layer after the coating solution has been applied onto the base and while the coating layer presents a constant drying rate.

“Before the coating layer thus formed presents a lapsed drying rate” usually refers to a time span of several minutes elapsing immediately after the coating solution for the colorant receiving layer has been applied. During the time span, the coating layer presents a constant drying rate, at which the content of the solvent in the coating layer decreases in proportion to elapsed time. The time during which the constant drying rate is presented is described in Kagaku kôgaku binran (“Chemical Engineering Handbook”, ed. The Society of Chemical Engineers, Japan, Tokyo: Maruzen, 1980, pp. 707-712).

As described above, after the coating solution for the colorant receiving layer has been applied, the coating layer thus formed is dried until it presents a lapsed drying speed. The coating layer is usually dried at 50 to 180° C. for 0.5 to 10 minutes (preferably 0.5 to 5 minutes), though the drying time will vary according to the applied amount of the coating solution.

The crosslinking agent-containing solution can be incorporated into the coating layer before it presents a lapsed drying speed by: (1) coating the crosslinking agent-containing solution onto the coating layer; (2) spraying the crosslinking agent-containing solution with a spray or the like; and (3) impregnating the base having the coating layer formed thereon in the crosslinking agent-containing solution.

Known curtain flow coaters, extrusion die coaters, air doctor coaters, bread coaters, rod coaters, knife coaters, squeeze coaters, reverse roll coaters, bar coaters, and the like can be used to coat the crosslinking agent-containing solution onto the coating layer. However, coaters that do not directly contact the formed coating layer, such as the extrusion die coaters, the curtain flow coaters, and the bar coaters, are preferably used.

The applied amount of the solution that includes at least the crosslinking agent and the mordant (the crosslinking agent-containing solution) is generally 0.01 to 10 g/m², and preferably 0.05 to 5 g/m², in terms of the crosslinking agent.

After the crosslinking agent-containing solution has been applied, the coating layer is usually heated to 40 to 180° C. for 5 to 30 minutes and dried so that the coating layer solidifies. The coating layer is preferably heated to 40 to 150° C. for 1 to 20 minutes.

When borax, boric acid, or borate is used as the crosslinking agent included in the crosslinking agent-containing solution, the coating layer having the crosslinking agent-containing solution applied thereon is preferably heated to 60 to 100° C. for 5 to 20 minutes. The crosslinking agent-containing solution may be also applied simultaneously with the coating solution for the colorant receiving layer.

In this case, the colorant receiving layer can be formed by simultaneously applying (in a stratified manner) the coating solution for the colorant receiving layer and the crosslinking agent-containing solution, which includes the crosslinking agent and the mordant, onto the base so that the coating solution for the colorant receiving layer contacts the base, and by drying the solutions so that they solidify.

The simultaneous coating (stratified coating) can be performed using extrusion die coaters and curtain flow coaters. The coating layers formed by the simultaneous coating are usually dried by being heated to 40 to 150° C. for 0.5 to 10 minutes, and preferably 40 to 100° C. for 0.5 to 5 minutes.

When borax, boric acid, or borate is used as the crosslinking agent included in the crosslinking agent-containing solution, the coating layers are preferably heated to 60 to 100° C. for 5 to 20 minutes.

When the simultaneous coating (stratified coating) is carried out by an extrusion die coater, the two coating solutions are simultaneously discharged so as to form stratified layers near a discharge port of the extrusion die coater, namely, before the stratified layers are applied onto the base, and in this state, the stratified layers are applied onto the base. Since the two superposed layers of the coating solutions before application thereof onto the base easily cause crosslinking at an interface of the two layers when they are applied onto the base, the two coating solutions which are being discharged easily mix with each other near the discharge port of the extrusion die coater, and the viscosity of the two solutions easily increases, which may cause trouble in the application operation. Accordingly, when the above simultaneous coating is performed, in addition to the application of the coating solution for the colorant receiving layer and the crosslinking agent-containing solution including the crosslinking agent and the mordant, a solution for a barrier layer (a solution for an intermediate layer), which is formed by a material not reacting with the crosslinking agent, is applied between the two solutions to simultaneously form a three-layered structure.

The solution for the barrier layer can be selected without restrictions as long as it does not react with the crosslinking agent and can form a liquid film. Examples include an aqueous solution containing a trace amount of a water-soluble resin which does not react with the crosslinking agent, water, and the like.

The water-soluble resin serves as a thickener or the like and is used in view of application characteristics. Examples include polymers such as hydroxypropylmethyl cellulose, methyl cellulose, hydroxyethylmethyl cellulose, polyvinyl pyrrolidone, and gelatin.

The solution for the barrier layer may also include the above-described mordant.

After the colorant receiving layer has been formed on the base, surface smoothness, glossiness, transparency, and strength thereof can be improved by using a super calender or a gloss calender to nip the base having the colorant receiving layer formed thereon between a pair of heated and pressed rolls for a calender treatment. However, since the calender treatment may decrease the porosity (i.e., decrease ink absorption), the calender treatment needs to be performed under conditions which cause little decrease in the porosity.

The temperature of the rolls during the calender treatment is preferably 30 to 150° C., and more preferably 40 to 100° C.

The linear load between the rolls during the calender treatment is preferably 50 to 400 kg/cm, and more preferably 100 to 200 kg.

In the case of ink jet recording, the colorant receiving layer needs to have sufficient absorption capacity to absorb all droplets. Therefore, the thickness of the colorant receiving layer needs to be determined in relation to the porosity of the layer. For example, when the amount of ink is 8 nL/mm² and the porosity is 60%, the thickness of the layer needs to be about 15 μm or more.

In this regard, in the case of ink jet recording, the thickness of the colorant receiving layer is preferably 10 to 50 μm.

Further, the pore size of the colorant receiving layer is preferably 0.005 to 0.030 μm, and more preferably 0.01 to 0.025 μm in median size.

The porosity and the median pore size can be measured using a mercury porosimeter (commercial name: PORESIZER 9320-PC2, manufactured by Shimadzu Corporation).

Further, it is preferable that the colorant receiving layer has excellent transparency. As a measure of transparency, the haze value at the time of forming the colorant receiving layer on the transparent film base is preferably 30% or less, and more preferably 20% or less.

The above haze value can be measured using a hazemeter (HGM-2DP, manufactured by Suga Test Instruments Co., Ltd.).

An undercoat layer may be formed on the base in order to increase adhesion between the colorant receiving layer and the base and to adjust electrical resistance.

The colorant receiving layer may be formed on only one side of the base or may be formed on both sides thereof so as to suppress deformation such as curls. When the colorant receiving layer is formed on only one side of the base for use in an OHP or the like, an anti-reflection film may be formed on the side opposite to the side on which the colorant receiving layer is formed, or may be formed both sides of the base in order to increase light transmittance.

As described above, glossiness and surface smoothness can be ensured, and bleeding of printed images with time under conditions of high temperature and high humidity can be suppressed, by applying a boron compound on the surface of the base and forming the colorant receiving layer thereon.

Moreover, the colorant receiving layer includes the inorganic pigment particles and has a three-dimensional mesh structure having a porosity of 50 to 80%. The colorant receiving layer can ensure excellent ink receptivity such as good ink absorption, formation of images at high resolution and with high density, and the formed images having high resistance to light and water.

### EXAMPLES

The present invention will now be described by, but is not limited to, the following Examples. “Parts” and “%” in the Examples represent “parts by mass” and “% by mass”, respectively.

Manufacturing of Sheet for Ink Jet Recording

### Example 1

Manufacturing of Base B

A surface of art paper (OK KANETO, manufactured by Oji Paper Co., Ltd.) having a weight of 186 g/m² was subjected to a corona discharge treatment. High-density polyethylene was coated onto the surface using a melt extrusion machine to form a mat resin layer having a thickness of 19 μm. (Hereinafter, the surface having the resin layer formed thereon may be referred to as the “back surface”.)

After a corona discharge treatment had been carried out on the resin layer on the back surface, a dispersion, in which aluminum oxide (ALUMINASOL 100 produced by Nissan Chemical Industries, Ltd.) and silicon dioxide (SNOWTEX O produced by Nissan Chemical Industries, Ltd.) were dispersed in water at a mass ratio of 1:2, was applied as an antistatic agent onto the resin layer so that the dry mass of the dispersion became 0.2 g/m².

Further, after a felt surface (front surface) of the base paper had been subjected to a corona discharge treatment, low-density polyethylene, which included 10% by mass of anatase-type titanium dioxide, a trace amount of an ultramarine blue pigment, and 0.01% by mass of an optical whitening agent (with respect to polyethylene) and had an MFR (i.e., melt flow rate) of 3.8, was coated onto the felt surface using the melt extrusion machine to form a glossy thermoplastic resin layer having a thickness of 29 μm on the base paper. (Hereinafter, this surface is sometimes referred to simply as the “surface”.) The sheet thus obtained was used as a base B.

Preparation of Coating Solution A for Colorant Receiving Layer

Materials (1) and (2) of the following composition were mixed and dispersed using a high-speed rotation colloid mill (CLEARMIX manufactured by M TECHNIQUE Co., LTD.) at 10000 rpm for 20 minutes. A material (3) was added to the dispersion and dispersed under the same conditions as described above to prepare a coating solution for a colorant receiving layer.

Composition of Coating Solution A for Colorant Receiving Layer

| | | |
|---|---|---|
| (1) | silica particles (inorganic pigment | 10.0 parts |
| | particles having an average primary | |
| | particle diameter of 7 nm; AEROSIL | |
| | 300 produced by Nippon Aerosil Co., | |
| | Ltd.) | |
| (2) | ion-exchange water | 60.0 parts |
| (3) | 9% aqueous solution of polyvinyl alcohol | 30.0 parts |
| | (water-soluble resin) (PVA 420 produced | |
| | by Kuraray Co., Ltd., saponification ratio | |
| | of 81.8%, polymerization degree of 2000) | |

Manufacturing of Sheet for Ink Jet Recording

Next, the coating solution A for a colorant receiving layer obtained above was applied onto the base B in an application amount of 200 ml/m² using an extrusion die coater (coating process) and dried at 80° C. with a hot air dryer (at a wind speed of 3 to 8 m/sec) until the concentration of the solid contents became 50%. The coated layer presented a constant drying rate during the drying. Immediately after the drying, the base B having the coated layer formed thereon was immersed in a crosslinking agent-containing solution A of the following composition for 30 seconds so that the crosslinking agent-containing solution A adhered to the coated layer in an amount of 20 g/m² (process for applying a crosslinking agent, an amine-based compound, and a mordant). Thereafter, the crosslinking agent-containing solution A adhered to the coated layer was dried at 80° C. for 10 minutes (drying process).

In this way, a colorant receiving layer having a thickness of 32 μm when dry was formed on the base B to obtain a sheet for ink jet recording of Example 1.

In the sheet for ink jet recording of Example 1, the mass ratio (PB ratio) of the silica particles to the water-soluble resin was 10:2.7, and the porosity of the colorant receiving layer (having a three-dimensional mesh structure) was 60%.

Composition of Crosslinking Agent-Containing Solution A

| | | |
|---|---|---|
| Boric acid (crosslinking agent) | 1.5 | parts |
| 10% solution of cationic mordant | 15.0 | parts |
| (PAA-10C produced by Nitto Boseki | | |
| Co., Ltd.) | | |
| Exemplified compound (1-35) | 3.0 | parts |
| 10% aqueous solution of a surfactant | 2.0 | parts |
| (F144D produced by Dainippon Ink & | | |
| Chemicals, Inc.) | | |
| Ion-exchange water | 78.5 | parts |

### Example 2

Manufacturing of Base A

Wood pulp formed of 100 parts of LBKP was struck and broken up by a double-disc refiner until the Canadian freeness became 300 ml. 0.5 parts of epoxidized behenic acid amide, 1.0 part of anion polyacrylamide, 0.1 part of polyamide polyamine epichlorohydrine, and 0.5 parts of cation polyacrylamide were added to the pulp at an absolute dry mass ratio with respect to the pulp to make base paper having a weight of 170 g/m², using a Fourdrinier paper machine.

In order to adjust the surface size of the base paper, 0.04% of an optical whitening agent (WHITEX BB produced by Sumitomo Chemical Co., Ltd.) was added to a 4% aqueous solution of polyvinyl alcohol, and the base paper was impregnated with the resulting mixture and dried so that the absolute dry mass of the mixture became 0.5 g/m². Thereafter, the base paper was subjected to a calender treatment to obtain base paper whose density had been adjusted to 1.05.

After a wire surface (back surface) of the obtained base paper had been subjected to a corona discharge treatment, high-density polyethylene was coated onto the wire surface using the melt extrusion machine to form a mat resin layer having a thickness of 19 μm. (Hereinafter, this surface of the resin layer is sometimes referred to as the “back surface”.)

After a corona discharge treatment had been carried out on the back surface of the resin layer, a dispersion, in which aluminum oxide (ALUMINASOL 100) and silicon dioxide (SNOWTEX O) were dispersed in water at a ratio of 1:2 (mass ratio), was applied as an antistatic agent onto the resin layer so that the dry mass thereof became 0.2 g/m².

Further, after a felt surface (front surface) of the base paper had been subjected to a corona discharge treatment, low-density polyethylene, which included 10% by weight of anatase-type titanium dioxide, a trace amount of an ultramarine blue pigment, and 0.01% by mass of an optical whitening agent (for polyethylene) and had an MFR (i.e., melt flow rate) of 3.8, was coated onto the felt surface using the melt extrusion machine to form a glossy thermoplastic resin layer having a thickness of 29 μm. (Hereinafter, this surface is sometimes referred to simply as the “surface”.) The sheet thus obtained was used as a base A.

Manufacturing of Sheet for Ink Jet Recording

A sheet for ink jet recording of Example 2 was manufactured in the same way as in Example 1, except that the base B in Example 1 was replaced by the base A, and that a crosslinking agent-containing solution B having the following composition was used in place of the crosslinking agent-containing solution A.

In the sheet for ink jet recording obtained in Example 2, the colorant receiving layer (three-dimensional mesh structure) had a porosity of 58%.

Composition of Crosslinking Agent-Containing Solution B

| | | |
|---|---|---|
| Boric acid (crosslinking agent) | 1.5 | parts |
| 10% solution of cationic mordant | 15.0 | parts |
| (PAA-10C produced by Nitto Boseki | | |
| Co., Ltd.) | | |
| Exemplified compound (1-37) | 3.0 | parts |
| 10% aqueous solution of a surfactant | 2.0 | parts |
| (F144D produced by Dainippon Ink & | | |
| Chemicals, Inc.) | | |
| Ion-exchange water | 78.5 | parts |

### Example 3

Manufacturing of Sheet for Ink Jet Recording

A sheet for ink jet recording of Example 3 was manufactured in the same way as in Example 1, except that the base B in Example 1 was replaced by the base A, and that a crosslinking agent-containing solution C having the following composition was used in place of the crosslinking agent-containing solution A.

In the sheet for ink jet recording obtained in Example 3, the colorant receiving layer (three-dimensional mesh structure) had a porosity of 57%.

Composition of Crosslinking Agent-Containing Solution C

| | | |
|---|---|---|
| Boric acid (crosslinking agent) | 1.5 | parts |
| 10% solution of cationic mordant | 15.0 | parts |
| (PAA-10C produced by Nitto Boseki | | |
| Co., Ltd.) | | |
| Exemplified compound (1-42) | 3.0 | parts |
| 10% aqueous solution of a surfactant | 2.0 | parts |
| (F144D produced by Dainippon Ink & | | |
| Chemicals, Inc.) | | |
| Ion-exchange water | 78.5 | parts |

### Example 4

Manufacturing of Sheet for Ink Jet Recording

A sheet for ink jet recording of Example 4 was manufactured in the same way as in Example 1, except that the base B in Example 1 was replaced by the base A, and that a crosslinking agent-containing solution D having the following composition was used in place of the crosslinking agent-containing solution A.

In the sheet for ink jet recording obtained in Example 4, the colorant receiving layer (three-dimensional mesh structure) had a porosity of 61%.

Composition of Crosslinking Agent-Containing Solution D

| | | |
|---|---|---|
| Boric acid (crosslinking agent) | 1.5 | parts |
| 10% solution of cationic mordant | 15.0 | parts |
| (PAA-10C produced by Nitto Boseki | | |
| Co., Ltd.) | | |
| Exemplified compound (1-4) and | 3.0 | parts |
| magnesium chloride | | |
| 10% aqueous solution of a surfactant | 2.0 | parts |
| (F144D produced by Dainippon Ink & | | |
| Chemicals, Inc.) | | |
| Ion-exchange water | 75.5 | parts |

### Example 5

Manufacturing of Sheet for Ink Jet Recording

A sheet for ink jet recording of Example 5 was manufactured in the same way as in Example 1, except that the base B in Example 1 was replaced by the base A, and that a crosslinking agent-containing solution E having the following composition was used in place of the crosslinking agent-containing solution A.

In the sheet for ink jet recording obtained in Example 5, the colorant receiving layer (three-dimensional mesh structure) had a porosity of 61%.

Composition of Crosslinking Agent-Containing Solution E

| | | |
|---|---|---|
| Boric acid (crosslinking agent) | 1.5 | parts |
| 10% solution of cationic mordant | 15.0 | parts |
| (PAA-10C produced by Nitto Boseki | | |
| Co., Ltd.) | | |
| Exemplified compounds (1-4) and | 3.0 | parts |
| zinc chloride | | |
| 10% aqueous solution of a surfactant | 2.0 | parts |
| (F144D produced by Dainippon Ink & | | |
| Chemicals, Inc.) | | |
| Ion-exchange water | 78.5 | parts |

### Example 6

Manufacturing of Sheet for Ink Jet Recording

A sheet for ink jet recording of Example 6 was manufactured in the same way as in Example 1, except that the base B in Example 1 was replaced by the base A, a coating solution B for a colorant receiving layer having the following composition was used instead of the coating solution A for a colorant receiving layer, and that a crosslinking agent-containing solution E, which had the following composition and whose pH had been adjusted to 9.0 by 25% ammonium water, was used in place of the crosslinking agent-containing solution A.

In the colorant receiving layer (three-dimensional mesh structure) of the sheet for ink jet recording obtained in Example 6, the mass ratio (PB ratio) of the silica particles to the water-soluble resin was 10:3.9, and the porosity was 62%.

Composition of Coating Solution B for Colorant Receiving Layer

| | | |
|---|---|---|
| Silica particles (inorganic pigment | 10.0 | parts |
| particles having an average primary | | |
| particle diameter of 7 nm; AEROSIL | | |
| 300 produced by Nippon Aerosil Co., | | |
| Ltd.) | | |
| 60% solution of cationic mordant | 2.0 | parts |
| (PAS-M-1 produced by Nitto Boseki Co., | | |
| Ltd.) | | |
| Exemplified compound (1-37) | 0.6 | parts |
| Boric acid | 0.1 | part |
| Ion-exchange water | 57.6 | parts |
| 9% aqueous solution of polyvinyl alcohol | 30.0 | parts |
| (water-soluble resin)(PVA 420 produced | | |
| by Kuraray Co., Ltd., saponification ratio | | |
| of 98.5%, polymerization degree of 2400) | | |

Composition of Crosslinking Agent-Containing Solution G

| | | |
|---|---|---|
| Boric acid (crosslinking agent) | 1.0 | part |
| 10% solution of cationic mordant | 5.0 | parts |
| (PAA-10C produced by Nitto Boseki | | |
| Co., Ltd.) | | |
| 10% aqueous solution of a surfactant | 2.0 | parts |
| (F144D produced by Dainippon Ink & | | |
| Chemicals, Inc.) | | |
| Ion-exchange water | 92.0 | parts |

### Comparative Example 1

Manufacturing of Sheet for Ink Jet Recording

A sheet for ink jet recording of Comparative Example 1 was manufactured in the same way as in Example 1, except that the base B in Example 1 was replaced by the base A, and that a coating solution C for a colorant receiving layer having the following composition was applied in place of the coating solution A for a colorant receiving layer by a bar coater so that the applied amount thereof after drying was 9 g/m².

In the colorant receiving layer (three-dimensional mesh structure) of the sheet for ink jet recording obtained in Comparative Example 1, the mass ratio (PB ratio) of the silica particles to the water-soluble resin was 10:6.3, and the porosity was 40%.

Composition of Coating Solution C for Colorant Receiving Layer

| | | |
|---|---|---|
| Amorphous silica particles A (inorganic | 6.5 | parts |
| pigment particles having an average | | |
| primary particle diameter of 5.9 nm; | | |
| FINESEAL X60 produced by Tokuyama | | |
| Corp.) | | |
| Amorphous silica particles B (inorganic | 3.5 | parts |
| pigment particles (average primary | | |
| particle diameter of 8 nm; MIZUCASIL | | |
| P78D produced by Mizusawa Industrial | | |
| Chemicals, Ltd.) | | |
| Polyvinyl alcohol (water-soluble resin) | 4.2 | parts |
| (R2150 produced by Kuraray Co., Ltd.) | | |
| 60% solution of cationic mordant | 3.5 | parts |
| (ARAFIX produced by Arakawa Chemical | | |
| Industries, Ltd.) | | |
| Optical whitening agent (WHITEX BB) | 3.0 | parts |
| Ion-exchange water | 79.5 | parts |

### Comparative Example 2

Manufacturing of Sheet for Ink Jet Recording

A sheet for ink jet recording of Comparative Example 2 was manufactured in the same way as in Example 1, except that the base B in Example 1 was replaced by the base A, and that a crosslinking agent-containing solution H having the following composition was used instead of the crosslinking agent-containing solution A. SUMILIZER-MDP-S in the crosslinking agent-containing solution H was water-insoluble.

In the sheet for ink jet recording obtained in Comparative Example 2, the colorant receiving layer (three-dimensional mesh structure) had a porosity of 61%.

Composition of Crosslinking Agent-Containing Solution H

| | | |
|---|---|---|
| Boric acid (crosslinking agent) | 1.5 | parts |
| 10% solution of cationic mordant | 15.0 | parts |
| (PAA-10C produced by Nitto Boseki | | |
| Co., Ltd.) | | |
| Tetramethyl-o-phenylenediamine | 3.0 | parts |
| 10% aqueous solution of a surfactant | 2.0 | parts |
| (F144D produced by Dainippon Ink & | | |
| Chemicals, Inc.) | | |
| Ion-exchange water | 78.5 | parts |

Measurement and Evaluation

<Ink Bleeding with Time>

An ink jet printer (PM-770C manufactured by Seiko Epson Corp.) was used to print grid patterns formed by alternate lines (each having a width of 0.28 mm) of magenta ink and black ink on each of the obtained sheets for ink jet recording.

The respective sheets were allowed to stand for 3 hours after the printing, and then stored in a bath at 40° C. and a relative humidity of 90% for 3 days. Subsequently, the width of the black lines was measured using an optical microscope and evaluated based on the following standards.

Standards

AA: Almost no bleeding with time was observed, and the print was well-preserved (the line width: 0.28 to 0.30 mm)

BB: A little bleeding with time was observed, but the print still had a practical use (the line width: 0.31 to 0.35 mm)

CC: Significant bleeding with time was observed, and the print had no practical use (the line width: 0.35 mm or more)

<Light Resistance>

Solid images of yellow (Y), magenta (M), cyan (C), black (K), blue (B), green (G), and red (R) were printed on the obtained sheets for ink jet recording by using the same printer as that used in the evaluation of ink bleeding with time. Thereafter, a lamp in a xenon weatherometer Ci65A (manufactured by ATLAS) was turned on for 3.8 hours to irradiate the sheets with light through a film which blocks ultraviolet rays having wavelengths of 365 nm or less, under the conditions of 25° C. and a relative humidity of 32%. Subsequently, the lamp was turned off and the sheets were allowed to stand for one hour under the conditions of 20° C. and a relative humidity of 91%. This cycle of turning on and off the lamp was repeated for 96 hours. The degree of discoloration of the respective colors in the images was visually observed and evaluated based on the following standards.

Standards

⊚: almost no discoloration was observed

◯: a little discoloration was observed

Δ: much discoloration was observed

×: significant discoloration was observed

<Test for Discoloration by Ozone>

Solid images of yellow (Y), magenta (M), cyan (C), black (K), blue (B), green (G), and red (R) were printed on the obtained sheets for ink jet recording, and images of a person and a landscape were further printed on the sheets by using the same printer as that used in the evaluation of ink bleeding with time. The printed sheets were allowed to stand in an atmosphere having 3 ppm of ozone for 8 hours. Thereafter, the degree of decrease in the coloration and density of the respective images was visually observed and evaluated based on the following standards.

Standards

⊚: almost no discoloration was observed

◯: a little discoloration was observed

Δ: much discoloration was observed

×: significant discoloration was observed

The results of evaluation are given in Table 1 below.

TABLE 1

| | | | | Coating solution | | | | | | | |
|---|---|---|---|---|---|---|---|---|---|---|---|
| | | | | containing | | | | | | | |
| | | Colorant receiving | | crosslinking | | | | | | | |
| | | layer | | agent | | | | Evaluation | | | |
| | | Compound | | Compound | | | | | | | |
| | | (basic skeleton) | | (basic skeleton) | | | | | Light | Coloration | |
| | | | Added | | Added | Ionization | | | resistance | of back- | Discolora- |
| | | Example | amount | | amount | energy | | Bleeding | of image | ground | tion by |
| | Base | No. | (part) | Example No. | (part) | (eV) | I/O value | with time | portions | portions | ozone |
| Example 1 | Base B | — | — | Hydrazine | 3 | 7.67 | 4.5 | AA | ◯ | ◯ | ◯ |
| | | | | (1-35) | | | | | | | |
| Example 2 | Base A | — | — | Quinoline | 3 | 8.62 | 1.0 | BB | ◯ | ◯ | ◯ |
| | | | | (1-37) | | | | | | | |
| Example 3 | Base A | — | — | Imidazol | 3 | 8.81 | 2.4 | AA | ◯ | ◯ | ◯ |
| | | | | (1-42) | | | | | | | |
| Example 4 | Base A | — | — | Thioether (1-4) + | 3 | 8.43 | 1.2 | AA | ◯ | ◯ | ◯ |
| | | | | magnesium | | | | | | | |
| | | | | chloride | | | | | | | |
| Example 5 | Base A | — | — | Thioether (1-4) + | 3 | 8.43 | 1.2 | BB | ◯ | ◯ | ⊚ |
| | | | | zinc chloride | | | | | | | |
| Example 6 | Base A | Quinoline | 0.6 | — | — | 8.62 | 2.4 | AA | ◯ | ◯ | ⊚ |
| | | (1-37) | | | | | | | | | |
| Comparative | Base A | — | — | — | — | | | CC | Δ | ◯ | X |
| Example 1 | | | | | | | | | | | |
| Comparative | Base A | — | — | Tetramethyl-o- | 3 | (6.87) | 1.2 | BB | ⊚ | X | ⊚ |
| Example 2 | | | | phenylene | | | | | | | |
| | | | | diamine | | | | | | | |

As can be seen from Table 1, the sheets for ink jet recording in Examples 1 to 6 were good in bleeding with time, light resistance, and resistance to ozone (resistance to discoloration by ozone). To the contrary, the sheet for ink jet recording in Comparative Example 1 could not satisfy all of the above characteristics, and the sheet for ink jet recording in Comparative Example 2 was poor in glossiness, resistance to light and water, and discoloration by ozone. Reference Experiments: Measurement and Evaluation of Resistance to Ozone in Pigment Solution System

Next, as reference experiments, the results of measurement of resistance to ozone and evaluation thereof, which were obtained when the compound relating to the present invention was used in a pigment solution system, will be described.

<Reference Example 1>

Ozone generated by an ozone generation device (OS-100 manufactured by Silver Reed) was discharged as bubbles at a discharge rate of 25 ml/min for 20 minutes in 20 ml of a distilled aqueous solution (hereinafter, may be referred to as the “aqueous solution of the pigment”) containing 5×10⁻⁵ mol/liter of a copper phthalocyanine-based pigment (a cyan dye for PM-770C, produced by Seiko Epson Corp.) and 5×10⁻³ mol/liter of the exemplified compound (1-35).

The absorption spectra of the aqueous solution of the pigment before and after the discharge of ozone as bubbles were measured using a multi-purpose self-recording spectrophotometer (MPS-2000 manufactured by Shimadzu Corporation). The residual ratio of the pigment in the aqueous solution was determined from changes in absorbancy at the maximum absorption wavelength, and resistance to ozone was evaluated.

<Reference Example 2>

The residual ratio of the pigment was determined and resistance to ozone was evaluated in the same way as in Reference Example 1, except that the exemplified compound (1-37) was used instead of the exemplified compound (1-35) in Reference Example 1.

<Reference Example 3>

The residual ratio of the pigment was determined and resistance to ozone was evaluated in the same way as in Reference Example 1, except that the exemplified compound (1-42) was used instead of the exemplified compound (1-35) in Reference Example 1.

<Reference Example 4>

The residual ratio of the pigment was determined and resistance to ozone was evaluated in the same way as in Reference Example 1, except that distilled water, which was the solvent for the aqueous solution of the pigment, was replaced with methanol, and that the exemplified compound (1-43) was used instead of the exemplified compound (1-35) in Reference Example 1.

<Reference Comparative Example 1>

The residual ratio of the pigment was determined and resistance to ozone was evaluated in the same way as in Reference Example 1, except that the exemplified compound (1-35) in Reference Example 1 was not used.

The results of Reference Examples 1 to 4 and Reference Comparative Example 1 are shown in Table 2 below.

TABLE 2

| | Compound | | |
|---|---|---|---|
| | (example | | Residual ratio |
| | No.) | Solvent | of pigment |
| Reference Example 1 | (1-35) | Distilled water | 85% |
| Reference Example 2 | (1-37) | Distilled water | 90% |
| Reference Example 3 | (1-42) | Distilled water | 87% |
| Reference Example 4 | (1-43) | Methanol | 75% |
| Reference Comparative | None | Distilled water | 58% |
| Example 1 | | | |

It was confirmed from Table 2 that resistance to ozone in the pigment solution system was improved as well by the present invention.

According to the present invention, it is possible to provide a sheet for ink jet recording that stably holds an image printed thereon without image bleeding even if the sheet is stored in a hot and humid environment for a long period of time, that has excellent resistance to ozone and prevents the recorded image from becoming discolored through time, and that has excellent resistance to light in image portions.

What is claimed is:

1. A sheet for ink jet recording, comprising at least one water-soluble compound whose basic skeleton has an ionization energy of 7.0 to 9.0 eV.

2. The sheet for ink jet recording of claim 1, wherein the basic skeleton of the water-soluble compound has an ionization energy of 7.2 to 8.8 eV.

3. The sheet for ink jet recording of claim 1, wherein the basic skeleton of the water-soluble compound has an ionization energy of 7.5 to 8.5 eV.

4. The sheet for ink jet recording of claim 1, wherein the water-soluble compound contains at least one of a hydroxyl group, a carboxyl group, and a sulfonic group in a molecule.

5. The sheet for ink jet recording of claim 1, wherein the I/O value of the water-soluble compound is no less than 0.5.

6. The sheet for ink jet recording of claim 1, wherein the I/O value of the water-soluble compound is no less than 0.8.

7. The sheet for ink jet recording of claim 1, wherein the I/O value of the water-soluble compound is no less than 1.2.

8. The sheet for ink jet recording of claim 1, wherein the content of the water-soluble compound is 0.1 to 10% by mass, based on the total solids of a colorant receiving layer.

9. The sheet for ink jet recording of claim 1, further comprising at least one metal compound.

10. The sheet for ink jet recording of claim 9, wherein the metal compound is selected from the group consisting of magnesium, calcium, aluminum, and zinc.

11. A sheet for ink jet recording comprising a base having formed thereon a colorant receiving layer, the colorant receiving layer having a three-dimensional mesh structure with a porosity of 50 to 80% and including inorganic particles (x) having an average primary particle diameter of no more than 20 nm, a water-soluble resin (y) at a mass ratio (x:y) of 1.5:1 to 10:1, a crosslinking agent for the water-soluble resin, an organic cationic mordant, and at least one water-soluble compound whose basic skeleton has an ionization energy of 7.0 to 9.0 eV.

12. The sheet for ink jet recording of claim 11, wherein the basic skeleton has an ionization energy of 7.2 to 8.8 eV.

13. The sheet for ink jet recording of claim 11, wherein the basic skeleton has an ionization energy of 7.5 to 8.5 eV.

14. The sheet for ink jet recording of claim 11, wherein the colorant receiving layer includes at least one metal compound.

15. The sheet for ink jet recording of claim 14, wherein the metal compound is selected from the group consisting of magnesium, calcium, aluminum, and zinc.

16. The sheet for ink jet recording of claim 11, wherein the organic cationic mordant is polyallylamine-based.

17. The sheet for ink jet recording of claim 11, wherein the water-soluble resin is polyvinyl alcohol.

18. The sheet for ink jet recording of claim 11, wherein the crosslinking agent is one of a boric acid and a borate.

19. The sheet for ink jet recording of claim 11, wherein the inorganic particles are silica particles.

20. The sheet for ink jet recording of claim 11, wherein the inorganic particles have a pseudo-boehmite structure.
